(19) United States
(12) Patent Application Publication
(10) Pub. No.: US 2026/0122447 A1
(43) Pub. Date: Apr. 30, 2026

(54) METHODS FOR EXTRACTING A DESIRED SIGNAL FROM UNDESIRED SIGNALS USING STEREO AUDIO DEVICES

(71) Applicant: OHMIC TECHNOLOGIES INC., Montreal (CA)

(72) Inventors: Carlos Antonio MENDES DA COSTA JUNIOR, Montreal (CA); Mark George Azmy Beshay GEORGY, Montreal (CA)

(21) Appl. No.: 19/431,711

(22) Filed: Dec. 23, 2025

Related U.S. Application Data
(63) Continuation of application No. PCT/IB2024/056374, filed on Jun. 29, 2024.
(60) Provisional application No. 63/524,528, filed on Jun. 30, 2023.

(51) Int. Cl. H04S 7/00; H04R 5/04; H04S 1/00

(52) U.S. Cl. CPC H04S 7/307; H04R 5/04; H04S 1/007

(57) ABSTRACT

A system and method for isolating a desired signal in the presence of undesired stereo audio signals, are presented. The disclosed embodiments provide a receiver that receives the desired and undesired signals and a modified bridge arrangement comprising a real branch having a fixed impedance level and a virtual branch having an adjustable impedance level. The combined desired and undesired signals are routed to the real branch to provide a first voltage signal and the undesired signal is routed to the virtual branch to provide a second voltage signal. The second impedance level of the virtual branch is dynamically adjusted to match the first impedance level of the real branch, such that a difference between the first and second voltage signals results in the cancellation of the undesired stereo audio signals such that the desired signal remains isolated.

### CROSS-REFERENCE TO RELATED APPLICATIONS

The present application is a continuation application of PCT Patent Application No. PCT/IB2024/056374, filed Jun. 29, 2024, which claims priority to U.S. Provisional Patent Application No. 63/524,528, filed Jun. 30, 2023, entitled “Methods for Signal Extraction Using Stereo Audio Devices”, which is incorporated by reference herein in its entirety.

### BACKGROUND

Stereo audio devices are electronic devices that produce sound from two or more separate channels, providing a more immersive and realistic listening experience. The use of stereo audio has become prevalent in various fields, including music, movies, gaming, and virtual reality. Stereo audio devices rely on the principle of binaural hearing, which refers to the ability of the human ear to localize sound based on differences in the time and intensity of sound waves that reach each ear. By using two or more separate channels, stereo audio devices can replicate this effect, creating the impression of sounds coming from different directions and distances. For example, stereo audio devices include headphones and hearing aids.

First, headphones have been a popular audio accessory for decades, primarily used for personal audio entertainment such as music, podcasts, and audiobooks. However, in recent years, advancements in technology have led to the integration of additional features and functionalities, turning headphones into a versatile multi-purpose device.

One of the advancements in headphones technology is noise cancellation. Broadly, noise cancellation headphones are designed to reduce external noise, providing an immersive audio experience. This technology has become increasingly popular in recent years, particularly for users in noisy environments such as commuters or office workers. Another advancement in headphones technology is the integration of voice assistants such as Alexa™ and Siri™. With this feature, users can interact with their headphones to perform tasks such as making phone calls, sending messages, setting reminders, and more, all through voice commands. In addition to audio playback and voice assistance, headphones can also incorporate health monitoring functionalities. This technology allows the headphones to monitor and track the user's body/health metrics such as heartbeats, breathing rates/patterns, tapping, blood pressure, and even perform user authentication/identification with the use of echo signals for example, to enable users to maintain an active and healthy lifestyle.

Second, hearing aids are small electronic devices worn in or behind the ear to amplify sound. Over the years, hearing aid technology has undergone advancements, resulting in a wide range of devices with different features and functionalities.

One of the advancements in hearing aid technology is the miniaturization of components, making hearing aids smaller and more discreet. Additionally, hearing aids have become more “intelligent” and can adapt to different sound environments, adjusting the sound output to match the user's specific needs. For example, some hearing aids can reduce background noise or enhance speech sounds, making conversations easier to follow. Another feature of modern hearing aids is connectivity. Hearing aids can now connect wirelessly to smartphones, televisions, and other audio devices, allowing users to stream audio directly to their hearing aids. This feature makes it easier for users to listen to phone calls, music, or television without the need for external speakers or headphones. Additionally, many hearing aids now come with rechargeable batteries, eliminating the need to replace disposable batteries frequently. This feature is not only more convenient but also more environmentally friendly.

### SUMMARY

Developers have devised methods and devices for overcoming at least some drawbacks present in prior art solutions.

Developers have realized that adding new features and functionalities to stereo audio devices, such as headphones, for example, comes at a cost. This extra cost is often related to at least one of power consumption, price, and size. This is due to the need for integration of specialized sensors because headphones drivers are used as an output device, where an electrical signal is converted to an audio signal. Nonetheless, headphones drivers can simultaneously be used as an output and an input device, thus eliminating the need for extra sensors to enable, for example, the previously mentioned features.

In at least some embodiments of the present technology, there are provided methods and systems to turn regular headphones, headsets, earbuds, and/or hearing aids into “smart” devices, without the addition of extra sensors, to enable features, such as, but not limited to, user authentication, touch gesture control, and the extraction of biometric data. At least some methods and systems may allow enabling stereo music output while also providing the features non-exhaustively listed above.

Broadly, Multi-Band AC Bridge (MBACB) is a type of Multi-Band Amplitude and Phase Equalizer (MBAPE) that works as a “virtual” speaker allowing for audio cancellation in different bands and irrespective of whether the audio signal is of a mono type or of a stereo type. In some embodiments, the MBACB can be used for the purpose of cancelling an audio signal while capturing signals originating from an audio device such as headphones, headsets, earbuds and/or hearing aids.

It is contemplated that in at least some embodiments, methods and systems are provided for extracting information from an audio device without the use of additional and potentially specialized sensors. Developers have realized that implementing such methods and/or systems into audio devices may be beneficial for manufacturers of the audio devices and/or enabling additional features without incurring additional cost.

In at least some embodiments, audio devices contemplated herein may make use of an AC bridge tuned for different frequency bands. The AC bridge can be used to reduce and/or cancel common-mode signals. For example, the AC bridge can be used to remove audio and other artifacts from the signal of interest, and leave a target signal, being the signal to be extracted for a given purpose. A signal can be acquired using an Analog-to-Digital Converter (ADC), which transmits data to a host, where signal processing is applied, and the processed signal is interpreted in a given context. For example, the processed signal may be used to extract a heart rate, used to identify a specific user wearing the device, or to detect touch-based commands performed by the user on the audio device.

Additionally, or alternatively, the AC bridge may be used to generate a virtual speaker such that the audio signal is evenly split between the branch containing a real speaker and a branch containing a virtual speaker, thus allowing for its cancellation by subtraction, for example. It should be noted that when the branches are matched, the audio signal is evenly split. If branches are not yet matched (e.g., control loop has not converged to the final control values), the signal is not evenly split for a fraction of a second. It is contemplated that each branch can be tuned to a specific band in order to more closely match the real speaker's impedance behavior.

Developers of the present technology have realized that speaker behavior is complex and cannot be represented only with resistors and capacitors. Alternatively, speaker behavior can be represented by an equivalent network of passive components, e.g., resistors, capacitors, and inductors. Broadly, a speaker equivalent circuit, also known as the electrical model of a speaker, is a simplified representation of the electrical behavior of a loudspeaker. It consists of electrical components that approximate the various mechanical and acoustical properties of the speaker. A speaker equivalent circuit can facilitate the analysis and design of audio systems by providing a mathematical model that can be easily manipulated using standard circuit theory. At least some speaker equivalent circuit include:
voice coil resistance (R): Represents the resistance of the voice coil wire. It causes power dissipation and is a crucial factor in determining the efficiency of the speaker;
mechanical compliance (Cms): Represents the mechanical compliance or stiffness of the speaker's suspension system. It affects the resonant frequency and the speaker's ability to reproduce low-frequency sounds;
mechanical mass (Mms): Represents the effective mass of the diaphragm and the attached components. It influences the speaker's ability to respond to changes in input signals and affects its transient response;
mechanical resistance (Rms): Represents the mechanical damping or losses within the speaker's suspension system. It helps control unwanted resonances and reduces distortion; and
electromagnetic induction (Le): Represents the inductance caused by the interaction between the voice coil and the speaker's magnetic field. It affects the speaker's impedance and frequency response.

At least some of these components can be interconnected in the electrical model using electrical elements such as resistors, capacitors, and inductors. The values of these components are determined through measurements and characterization of the physical properties of the speaker.

Developers have realized that impedance behaviour can be cut in smaller portions, or bands, and each band can be matched to a simpler circuit that mimics the speakers' behaviour in that corresponding band (e.g., 0-100 Hz band). It is contemplated that another branch may be used to mimic the speaker's mid-frequency response, and another branch may be used to mimic the speaker's high frequency response. There could be as many branches as needed to cancel common-mode signals at the required frequencies to allow for desired signal extraction within the cancelled band.

Developers have realized that impedance behaviour can be matched by an active circuit that behaves like the passive network circuit used as the speaker equivalent circuit. In other words, capacitor and inductor behaviours can be “mimicked” by active circuits. In some embodiments, passive components with large values may be avoided. In some embodiments, a Full-Band AC Bridge (FBACB) can also be implemented using active components, resistors, capacitors, and the like.

Developers have realized that the impedance behaviour can also be represented in the digital domain. In some embodiments, an Analog to Digital Converter (ADC) can be used to capture the signal before the bridge and/or directly from the speaker. The signal before the bridge can then be passed by a digital version of the speaker model (captured by characterizing the speaker) and used to cancel the audio from the signal coming from directly from the speaker.

In the context of the present specification, a “server” is a computer program that is running on appropriate hardware and is capable of receiving requests (e.g., from devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g., received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “device” is any computer hardware that is capable of running software appropriate to the relevant task at hand. Thus, some (non-limiting) examples of devices include personal computers (desktops, laptops, netbooks, etc.), smartphones, and tablets, as well as network equipment such as routers, switches, and gateways. It should be noted that a device acting as a device in the present context is not precluded from acting as a server to other devices. The use of the expression “a device” does not preclude multiple devices being used in receiving/sending, carrying out or causing to be carried out any task or request, or the consequences of any task or request, or steps of any method described herein.

In the context of the present specification, a “database” is any structured collection of data, irrespective of its particular structure, the database management software, or the computer hardware on which the data is stored, implemented, or otherwise rendered available for use. A database may reside on the same hardware as the process that stores or makes use of the information stored in the database or it may reside on separate hardware, such as a dedicated server or plurality of servers. It can be said that a database is a logically ordered collection of structured data kept electronically in a computer system.

In the context of the present specification, the expression “information” includes information of any nature or kind whatsoever capable of being stored in a database. Thus, information includes, but is not limited to audiovisual works (images, movies, sound records, presentations etc.), data (location data, numerical data, etc.), text (opinions, comments, questions, messages, etc.), documents, spreadsheets, lists of words, etc.

In the context of the present specification, the expression “component” is meant to include software (appropriate to a particular hardware context) that is both necessary and sufficient to achieve the specific function(s) being referenced.

In the context of the present specification, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1A depicts a schematic representation of a Maxwell Capacitance Bridge.

FIG. 1B depicts a schematic representation of a Maxwell Inductance Bridge.

FIG. 2A depicts a schematic representation of a Maxwell-Wien Bridge.

FIG. 2B depicts a schematic representation of a modified Maxwell-Wien Bridge.

FIG. 3A depicts a schematic representation of a system for desired signal acquisition in the presence of undesired signals.

FIG. 3B depicts the schematic representation of the system of FIG. 3A incorporating a buffer.

FIG. 4 depicts a schematic representation of the application of the system of FIG. 3B implemented in a stereo system with left and right speakers.

FIG. 5 depicts a schematic representation of the application of the system of FIG. 3B implemented in a stereo system with left and right speakers with buffers applied to each of the real and virtual branches.

FIG. 6 depicts a high-level schematic representation of a control loop in accordance with at least some embodiments of the present technology.

FIG. 7 depicts a high-level schematic representation of a Look-up-Table (LUT) and a Phase and Amplitude Detector (PAD) configuration as contemplated in accordance with at least some non-limiting embodiments of the present technology.

FIG. 8 depicts a schematic representation of a multi-band AC bridge of an electronic system as contemplated in accordance with at least some non-limiting embodiments of the present technology.

FIG. 9 depicts a graphical representation of an amplitude and phase approximated compensation for a multiband reference transfer function, indicated by dashed black line.

FIG. 10 depicts a schematic representation of a phase and amplitude detector (PAD) with a look-up table (LUT) in accordance with at least some non-limiting embodiments of the present technology.

FIG. 11 depicts a schematic representation of a control loop for impedance compensation in accordance with at least some non-limiting embodiments of the present technology.

FIG. 12 depicts a schematic representation of a digital implementation for impedance compensation in accordance with at least some non-limiting embodiments of the present technology.

FIG. 13 depicts a schematic representation of a full-band AC bridge for impedance compensation in accordance with at least some non-limiting embodiments of the present technology.

FIG. 14 is a schematic representation of a system for performing stereo audio cancellation for extraction of headphone signals, in accordance with at least some non-limiting embodiments of the present technology.

FIG. 15 is a schematic representation of a second system for performing stereo audio cancellation for extraction of headphone signals, in accordance with at least some non-limiting embodiments of the present technology.

FIG. 16 is schematic representation of a configuration for performing stereo audio cancellation for extraction of headphone signals, in accordance with at least some non-limiting embodiments of the present technology.

FIG. 17 is a schematic representation of another configuration for performing stereo audio cancellation for extraction of headphone signals, in accordance with at least some non-limiting embodiments of the present technology.

FIG. 18 is a schematic representation of another configuration for performing stereo audio cancellation for extraction of headphone signals, in accordance with at least some non-limiting embodiments of the present technology.

FIG. 19 depicts the use of two power amplifiers for the schematic representations of the configurations provided by previous configurations, in accordance with at least some non-limiting embodiments of the present technology.

FIG. 20 depicts time and frequency responses for the desired signals in the presence of an undesired stereo audio signals without undesired signal cancellation with comparison to undesired signal cancellation, in accordance with at least some non-limiting embodiments of the present technology.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some embodiments of the present technology, the processor may be a general-purpose processor, such as a central processing unit (CPU) or a processor dedicated to a specific purpose, such as a digital signal processor (DSP). Moreover, explicit use of the term a “processor” should not be construed to refer exclusively to hardware capable of executing software, and may implicitly include, without limitation, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown. Moreover, it should be understood that module may include for example, but without being limitative, computer program logic, computer program instructions, software, stack, firmware, hardware circuitry or a combination thereof which provides the required capabilities.

The disclosed embodiments are directed to monitoring, tracking, and processing users' body/health metrics, as sensed by stereo audio devices, such as headphones and hearing aids. Such sensed body/health metrics are heretofore referenced as “desired signals” and include, for example, detected heartbeats, breathing rates/patterns, tapping, blood pressure, and even perform user authentication/identification via the use of echo signals.

With these fundamentals in place, we will now consider some non-limiting examples to illustrate various implementations of aspects of the present technology.

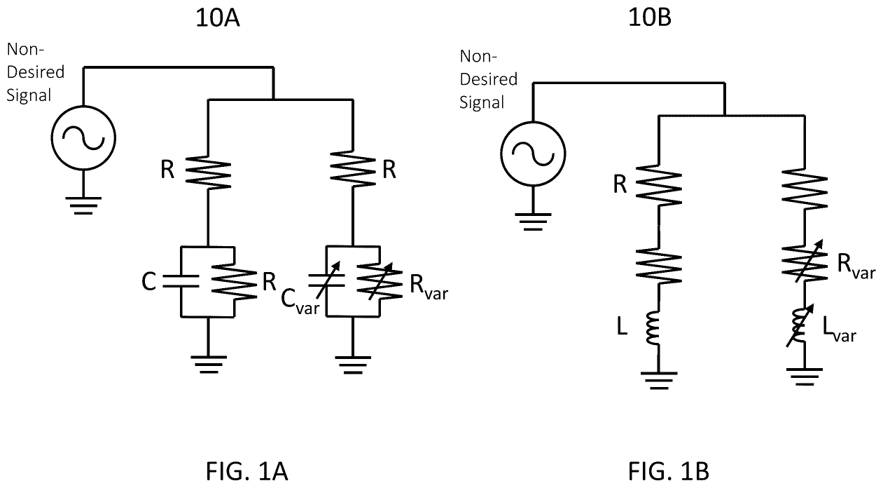

Developers have realized that AC bridges 10A, 10B are often used to determine the value of impedances, such as, inductance L and/or capacitance C, as shown in FIGS. 1A and 1B. For example, the AC bridge can be automatically “nulled” to accurately measure small impedance variations. The nulling can be performed via a use of a symmetrical bridge, where an unknown resistance and capacitance/inductance are balanced using voltage-controlled resistors and capacitors. It is contemplated that the AC bridge can be automatically nulled by using a control form.

In some embodiments, nulling may be performed in a similar manner to what is disclosed in an article entitled “AN-C2V: An Auto-Nulling Bridge-Based Signal Conditioning Circuit for Leaky Capacitive Sensors”, published on 23 Feb. 2020, authored by Shahid Malik et al., the contents of which is incorporated herein by reference in its entirety.

Although this solution works well for a configuration where the load is composed of only a resistor and capacitor, developers have realized that for a configuration in which an inductor is added as a load, the nulling becomes more complex, using voltage-controlled inductors (VCI) is required.

Broadly, a voltage-controlled inductor (VCI) is an electronic component that can change its inductance value in response to changes in voltage. An inductor is a passive electronic component that stores energy in a magnetic field when current flows through it. Typically, the inductance of an inductor is fixed and depends on its physical construction. However, a VCI uses a voltage-controlled magnetic field to vary its inductance. This is achieved by applying a control voltage to the inductor, which changes the magnetic permeability of the core material, altering the inductance value. This makes a VCI a useful component in various applications that require variable inductance.

It should be noted that VCIs may not be easily available to manufacturers, are relatively big in size and have a limited range. Developers have realized that instead of using a VCI, an asymmetrical AC bridge can be used, where the nodes of interest are balanced to achieve null and acquire the desired signal.

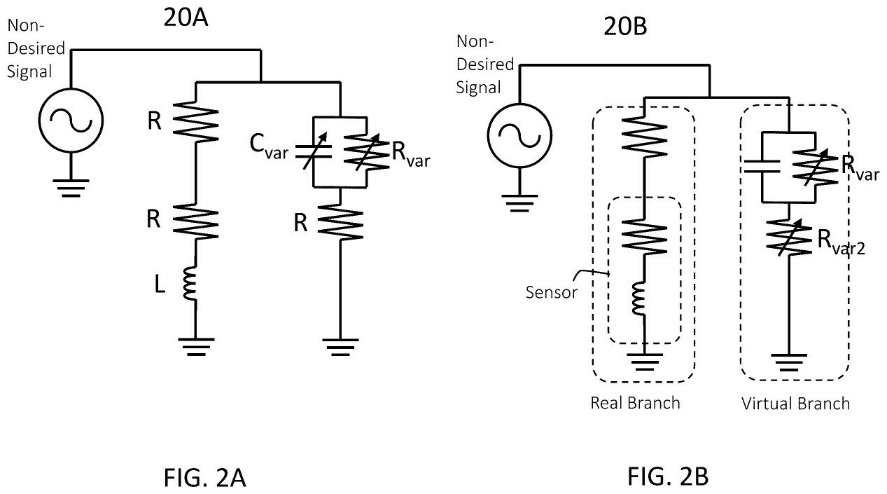

It should be noted that for implementing an asymmetrical AC bridge, two components are to be balanced, the in-phase component (i.e., amplitude), due to the unknown resistance of an inductance and/or capacitance, and the out-of-phase component (i.e., phase delay) due to the inductors and capacitors. An example of such a configuration 20A is shown in FIG. 2A, illustrating a Maxwell Inductance Capacitance Bridge, also known as the Maxwell-Wien Bridge. This bridge can measure the value of an unknown inductance L by using a variable resistor Rᵥₐᵣ and a variable capacitor Cᵥₐᵣ, and where the impedance configuration is asymmetrical.

Additionally, the variable capacitor can be replaced by a fixed one, and instead, use a second variable resistor Rᵥₐᵣ₂ as shown in the configuration 20B of FIG. 2B, which simplifies the balancing of the bridge since voltage-controlled resistors Rᵥₐᵣ, Rᵥₐᵣ₂ can be made, for example, by using depletion type MOSFETs or JFETs.

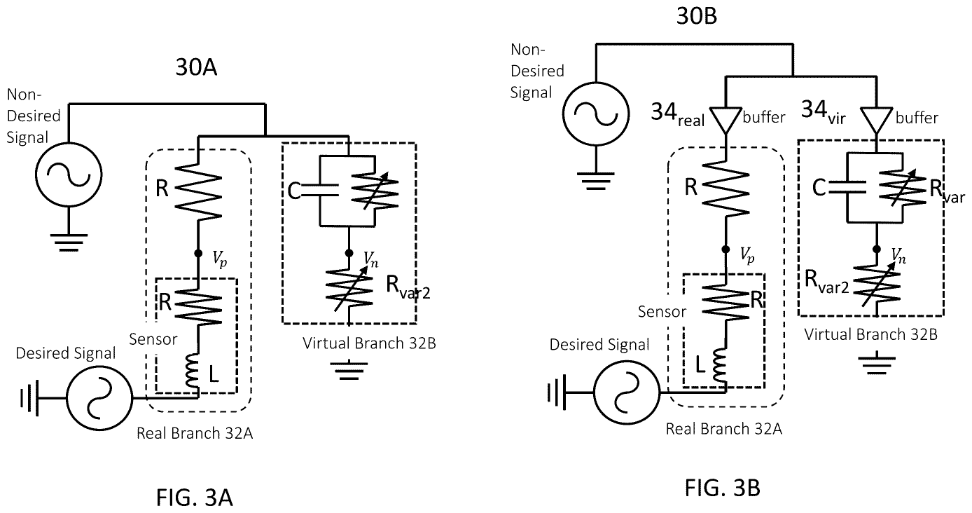

Developers have realized that the modified Maxwell-Wien Bridge configuration 20B of FIG. 2B can be used to acquire desired signals coming from a variety of inductive, capacitive, or resistive-based sensors, even in the presence of undesired audio signals, as shown by the configuration of 30A of FIG. 3A.

In one example, when looking from the undesired signal perspective (audio signal) and the desired signal is grounded (no signal coming from the sensors), the audio signal is provided equally in a real speaker branch 32A and a virtual speaker branch 32B since they are in parallel. If impedances C, Rᵥₐᵣ, Rᵥₐᵣ₂ are adjusted in the virtual branch such that we get Vn equal to Vp or that a gap between Vn and Vp is substantially reduced, these signals can be subtracted for cancelling the undesired signal. In another example, when looking from the desired signal perspective and undesired signal is grounded, a signal is provided at Vp (which is the desired signal). When Vn is subtracted from Vp, the desired signal is obtained because Vp contains both the desired and undesired signal, while Vn contains only the undesired signal.

Relatedly, FIG. 3B depicts configuration 30B employing the use of buffers in the configuration of FIG. 3A. The buffers 34ᵣₑₐₗ and 34ᵥᵢᵣ are respectively incorporated at the input of the real and virtual branches 32A, 32B and are configured to prevent the desired signal from being reduced.

An audio signal is an example of an undesired signal as the audio signal will interfere with the desired signal being extracted, so in our case audio is a non desired signal. However, this will not affect any audio quality.

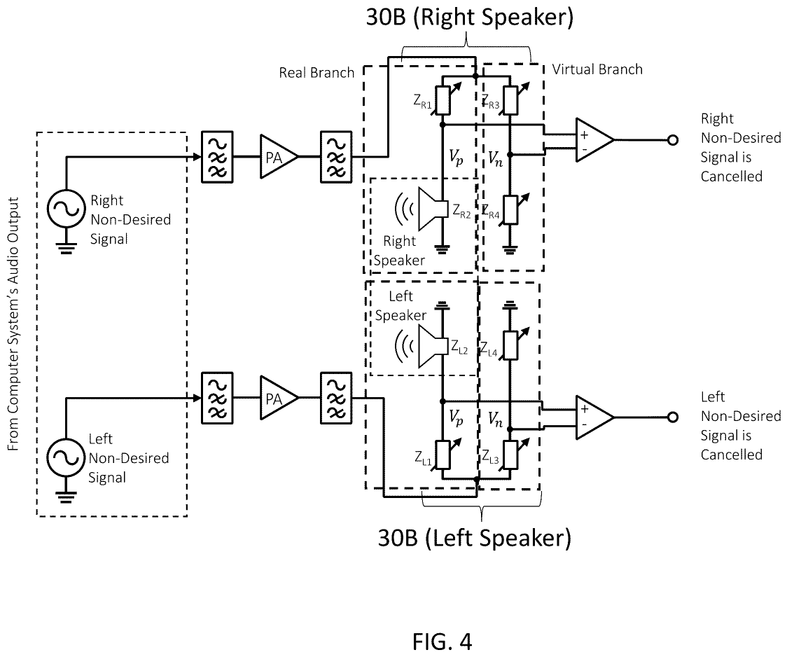

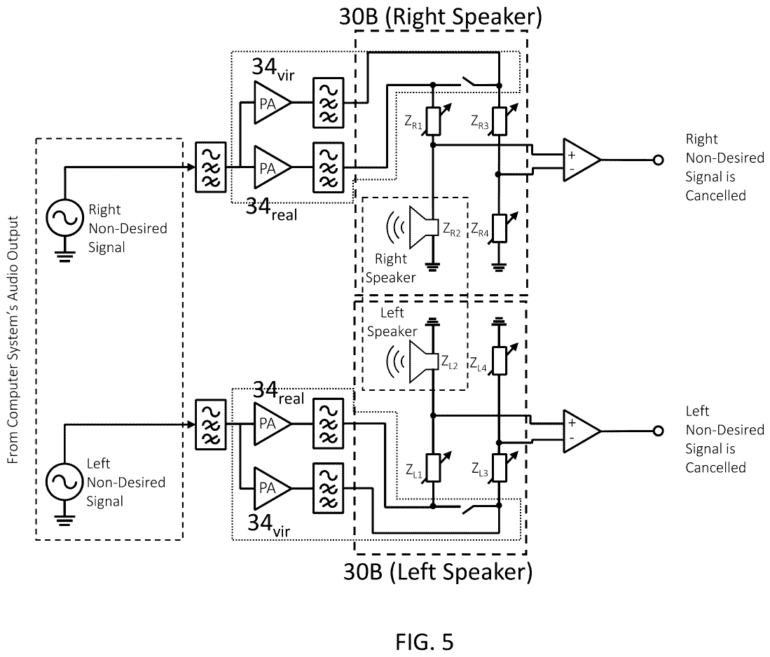

FIG. 4 depicts a schematic representation of the application of the configuration 30B of FIG. 3B in a stereo system with left and right speakers. Relatedly, FIG. 5 depicts the individual application of buffers 34_{real,} 34ᵥᵢᵣ to each of the real and virtual branches of each of the right and left speakers. The configuration and components of FIGS. 4, 5 will be described in greater detail below within the context of various implementations.

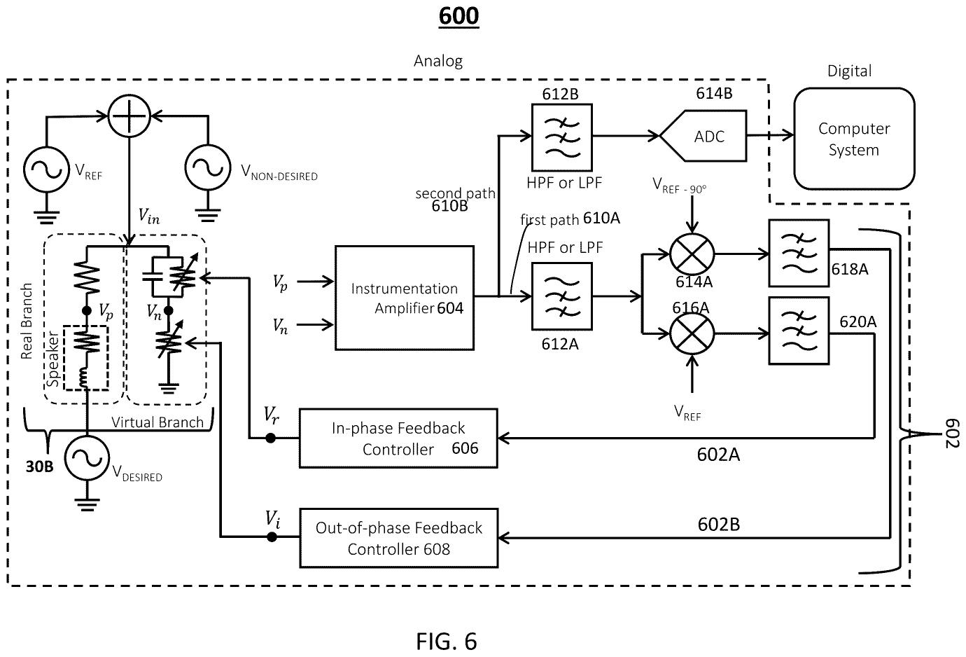

In at least some embodiments of the present technology, there is provided a system 60 with a control loop for providing auto nulling capability of the AC bridge, as it will be described in greater detail further below with reference to FIG. 6.

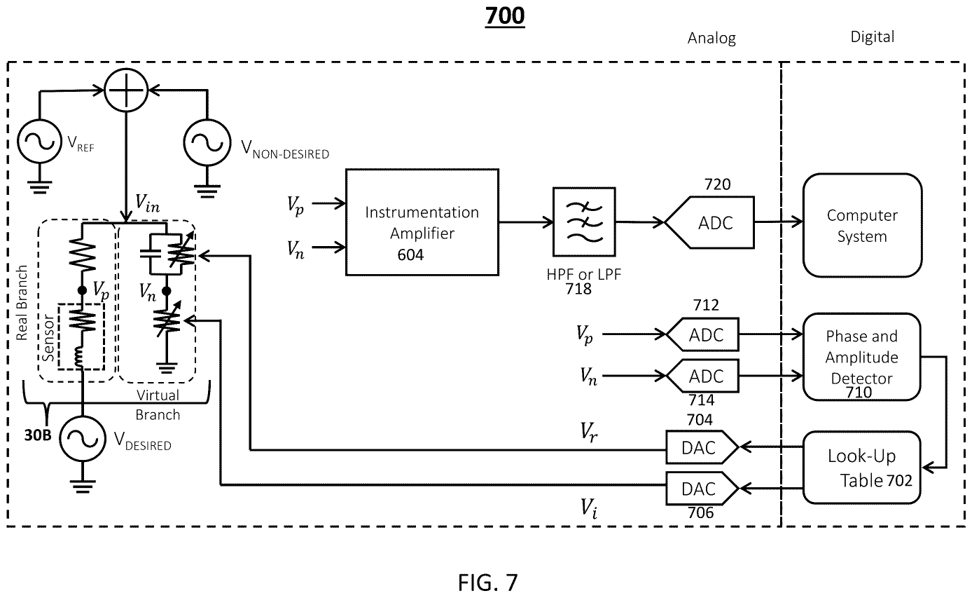

In at least some other embodiments of the present technology, there is provided a system 70 with a pre-computed Look-Up-Table (LUT) with a Phase and Amplitude Detector (PAD) for providing auto nulling capability of the AC bridge, as it will be described in greater detail below with reference to FIG. 7.

It should be noted that both the control loop and the LUT with PAD can be implemented entirely in the digital domain. However, developers realized that the LUT with PAD configuration may require comparatively less processing power because there is only an access to the pre-computed values saved on the memory. In contrast, the control loop can potentially provide a finer resolution, but at the cost of more processing power, since it involved in real-time calculations.

In some cases, it may be desirable to implement the LUT with PAD configuration on an embedded system with limited processing capability. In other cases, it may be desirable to implement the control loop configuration on a comparatively more powerful host device, like a smartphone or PC.

### Control Loop

With reference to FIG. 6, there is depicted a high-level schematic representation of a control loop configuration 600 that can be used in some of the embodiments of the present technology. The control loop 602 comprises two internal loops, a first loop 602A tasked with balancing an amplitude of a signal and a second loop 602B tasked with balancing a phase of the signal. In particular, a V_{ref} signal is combined with the V_{undesired} signal to produce a Vᵢₙ signal that is supplied to the modified Maxwell-Wien Bridge arrangement 30B noted above, in which the V_{desired} signal is supplied to the real branch 34ᵣₑₐₗ of the bridge arrangement 30B. The frequency of the V_{ref} signal is selected based on a particular frequency band in which the V_{undesired} signal is to be cancelled. In turn, the Vₚ and Vₙ signals are subtracted and amplified using an instrumentation amplifier 604. Broadly, an instrumentation amplifier 604 is an electronic device that is used to subtract and amplify signals, typically in the range of microvolts to millivolts. The instrumentation amplifier 604 can be a differential amplifier with input buffers and single-resistor gain control. The input to an instrumentation amplifier 604 can be derived from a sensor and/or transducer that converts a physical quantity, such as temperature, pressure, or strain, into an electrical signal. The instrumentation amplifier 604 may consist of multiple operational amplifiers (op-amps) and precision resistors that are configured to provide high-accuracy, high-gain amplification of the subtracted input signals. The op-amps can be configured in a differential configuration, which provides a high degree of common-mode rejection, suppressing any unwanted noise or interference that may be present in the input signal. In general, the gain of an instrumentation amplifier 604 can be dynamically adjusted by changing the value of a single external resistor, making it easy to optimize the amplifier for different input signal levels and application requirements. Besides, the input buffers present in the instrumentation amplifier 604 can remove the need for input matching. In addition, many instrumentation amplifiers 604 also provide adjustable gain offset capabilities and bandwidth settings, which further improve their flexibility and performance.

Returning to FIG. 6, the resulting Vₚ−Vₙ signal is forwarded to a first and second processing path 610A, 610B, respectively. In the first path 610A, the resulting Vₚ−Vₙ signal is filtered, in which the filter 612A may comprise a low-pass or high-pass filter depending on the particular frequency band being processed, as prescribed by the V_{ref} signal. The filtered Vₚ−Vₙ signal is then supplied to a mixer assembly 614A, 616A to mix the signal with the V_{ref} signal and an orthogonal V_{ref-90} signal, respectively. The output of the mixed Vₚ−Vₙ signal and V_{ref} signal is filtered 620A and forwarded to the first control loop 602A comprising an in-phase feedback controller 606. The in-phase feedback controller 606 is configured to generate a Vᵣ control signal that is supplied to the first variable resistor of the virtual branch of the modified Maxwell-Wien Bridge arrangement 30B to dynamically adjust the resistance therein in order to match the amplitude of the V_{undesired} signal for effective cancellation.

Relatedly, the output of the mixed Vₚ−Vₙ signal and V_{ref-90} signal is filtered 618A and forwarded to the second control loop 602B comprising an out-of-phase feedback controller 608. The out-of-phase feedback controller 608 is configured to generate a control Vᵢ signal that is supplied to the second variable resistor of the virtual branch of the modified Maxwell-Wien Bridge 30B arrangement to dynamically adjust the resistance therein in order to match the phase of the V_{undesired} signal for effective cancellation.

Along the second path 610B of the instrumentation amplifier 604 output, as depicted by FIG. 6, the resulting Vₚ−Vₙ signal is forwarded to a filter 612B which may comprise a low-pass or high-pass filter depending on the particular frequency band being processed, as prescribed by the Vref signal. The filtered Vₚ−Vₙ signal represents the effective cancellation of the V_{undesired} signal and, therefore, only contains the V_{desired} signal. The V_{desired} signal is then digitally sampled by using an Analog-to-Digital Converter (ADC) 614 to provide digital values of the V_{desired} signal. The digital values of the V_{desired} signal is then supplied to a host device or computer system for further processing/evaluation.

It should be appreciated that the in-phase and out-of-phase feedback controllers may comprise an integrator controller, and/or a Proportional, Integral, Derivative (PID) controller. Broadly, controllers may be used to zero-down the error between a measured value and a controlled value.

Additionally, or alternatively, the control loop can also be implemented in the digital domain, and the resulting digital control values can be converted to analog control voltages by the use of DACs. In some embodiments, digital potentiometers may be used instead of JFETs or MOSFETs and the control loop can be performed in the digital domain, so the control signals (Vi and Vr) can be generated in the digital domain and sent to the analog domain via the use of a DAC pin on a MCU, without departing from the scope of the present technology.

Moreover, as indicated, the configuration of FIG. 6 may be segregated into an analog portion and a digital portion. It will be appreciated that both, the analog and digital portions may be implemented in the headphones or in the host device.

### LUT & PAD

With reference to FIG. 7, there is depicted a high-level schematic representation of a configuration 700 incorporating a look up table (LUT) 702 and a phase and amplitude detector (PAD) 710 that can be used in at least some embodiments of the present technology. As shown, the circuitry involving the V_{ref}, V_{undesired}, and Vᵢₙ signals along with the modified Maxwell-Wien Bridge arrangement 30B is substantially similar to the circuitry of the FIG. 6 configuration 600. Thus, for the sake of brevity and tractability, we will not repeat the details of such circuitry and rely instead on the corresponding descriptions of FIG. 6.

Broadly speaking, a PAD 710 is an electronic circuit that is used to compare the phase and amplitude of two input signals. The PAD 710 is used in applications such as phase-locked loops (PLLs), where it is used to lock the phase and frequency of a reference signal to a feedback signal. The PAD 710 operates by comparing the phase and amplitude of the two input signals, and generating an output signal that represents the phase and amplitude difference between the two signals. The output signal is typically a voltage that is proportional to the phase and amplitude difference and can be used to dynamically adjust the phase and frequency of the reference signal to match that of the feedback signal.

In FIG. 7, the PAD 710 is configured to measure the mismatch between the Vₙ and Vₚ caused by the sensor so that the equivalent values for the modified Maxwell-Wien Bridge arrangement 30B can be set. In particular, as discussed above, the Vᵢₙ signal is the combination of the V_{ref} and V_{undesired} signals. Vₚ may be a resultant voltage based of the voltage divider ratio of the real branch and indicative of how much of the audio signal is going to the headphones. As discussed above, Vₙ should be the same as Vₚ (and/or substantially the same) by mimicking the voltage divider ratio by the control of the impedances in the virtual branch.

The Vₚ and Vₙ signals are subtracted and amplified using the instrumentation amplifier 604. The resulting Vₚ−Vₙ signal constitutes the V_{desired} signal as the V_{undesired} signal has been cancelled out due to the subtraction operation. The V_{desired} signal is then filtered, in which the filter 718 may comprise a low-pass or high-pass filter depending on the particular frequency band being processed, as prescribed by the V_{ref} signal. The filtered V_{desired} signal is forwarded to an ADC 720 to provide digital values of the V_{desired} signal. The digital values of the V_{desired} signal is then supplied to a host device or computer system for further processing/evaluation.

As shown, the Vₚ and Vₙ signals are respectively forwarded to corresponding ADCs 712, 714 to provide digital values of the Vₚ and Vₙ signals which, in turn, are forwarded to the PAD 710. As noted above, the PAD 710 compares the phase and amplitude of the Vₚ and Vₙ signals and generates an output voltage signal that represents the phase and amplitude difference between the two signals.

The phase and amplitude comparison calculation can be performed offline, or pre-computed, and the resulting values can be stored in the LUT 702. In real-time operation, a computer system can receive the in-use PAD's 710 values, access the LUT 702, and determines the corresponding Vᵢ and Vᵣ voltages to control, in this non-limiting example, a variable resistor such that Vₚ and Vₙ present the same amplitude and phase characteristics. It should be noted that the LUT 702 may be embodied as a table with pre-computed values of control signals vs input signals (amplitude and phase). The LUT 702 may be embodied as a set of values that are stored in memory. In some cases, when the LUT 702 is stored in non-volatile memory, values may not require upload every time the circuit is powered up.

Moreover, as indicated, the configuration 700 of FIG. 7 may be segregated into an analog portion and a digital portion. It will be appreciated that both, the analog and digital portions may be implemented in the headphones or in the host device.

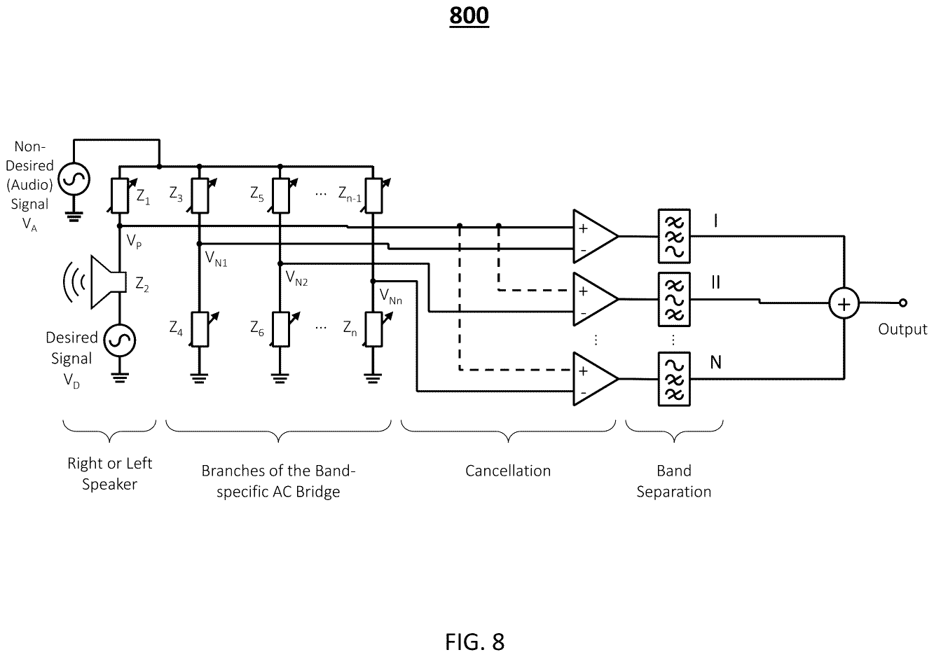

Developers of the present technology have also realized that in the case of more complex loads, involving multiple passive components, such as inductors, capacitors, and resistors (e.g., similar circuit to a speaker, where the frequency response cannot be simplified to neither a standalone resistor, an inductor plus resistor, or a capacitor plus resistor) a Multi-Band AC Bridge (MBACB) can be used for cancelling the undesired (audio) signal over a wide frequency band, while isolating and acquiring the desired signal. A non-limiting example of a MBACB configuration 800 as contemplated within the context of the present technology is depicted in FIG. 8. For the sake of clarity, only certain elements that are relevant to the understanding of this concept will be described.

Broadly speaking, the MBACB is designed to operate as a type of Multi-Band Amplitude and Phase Equalizer (MBAPE) that works as a virtual speaker to cancel undesired stereo type audio signals. In this manner, isolation/extraction of desired stereo audio signals may be achieved by headphones or other types of stereo audio receiving devices.

In some embodiments, the MBACB may allow for the cancellation in a signal band of interest and/or across multiple bands of interest, where different combination(s) of the frequency channels are used. In the illustrated multiband configuration 800, each branch of the band-specific AC bridge is used to approximate the amplitude and phase transfer function of the load (e.g., sensor or speaker), such that the impedances Z₂, Z₄ . . . Zₙ of the corresponding virtual branches match the impedances Z₁, Z₃ . . . Zₙ of the corresponding real branches to produce signal voltages V_{N1} through V_{Nn}. The signal voltages V_{N1} through V_{Nn} are then subtracted from Vₚ for each frequency channel to cancel the respective undesired audio stereo type signals in order to isolate the corresponding desired stereo signals. The cancellation of undesired signals occurs after the two respective branches are subtracted by an instrumentation amplifier. The corresponding desired signals are subsequently filtered by individual filters tuned to the bandwidth range of each respective frequency channel for separation. At the end, the output of each separation band filter is added together by a summing block, e.g., a summing amplifier. The filtered desired signals for the corresponding bandwidth channels are indicated by the frequency regions I, II . . . N. In turn, the filtered desired signals for the frequency regions are added to provide a combined desired signal output for further processing by a host device.

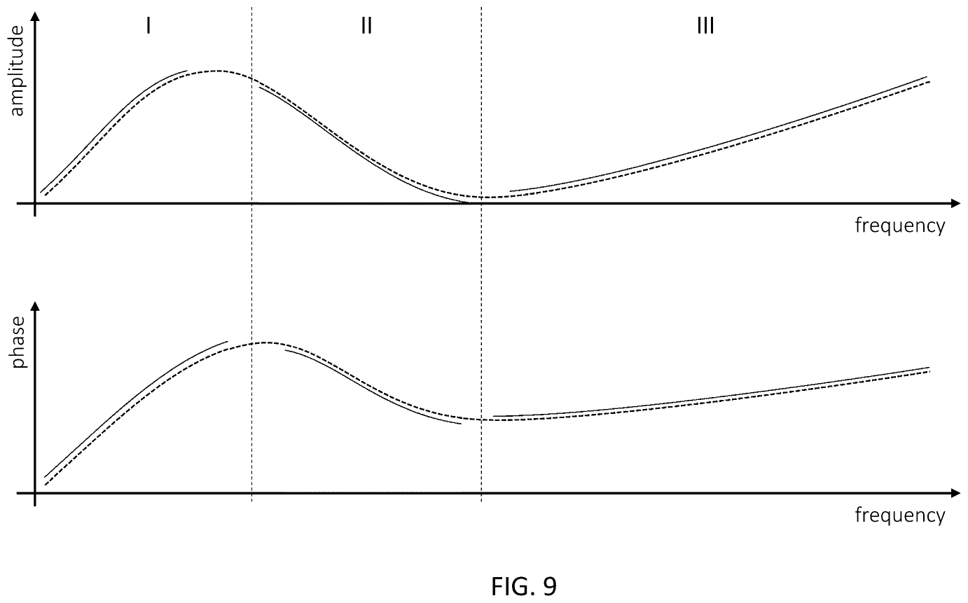

Relatedly, FIG. 9, depicts a graphical representation of an amplitude and phase-approximated compensation for an example of the 3 different frequency regions I, II, III of the reference transfer function of the FIG. 8 multiband configuration 800. The reference transfer function is indicated by dashed black lines. In order to balance the virtual speaker branch for each band, the 3 virtual speaker branches are tuned to provide the same response at a given frequency interval, thus allowing for reduction and cancellation of common undesired audio stereo signals. The red curve is the approximation achieved by the respective virtual speaker.

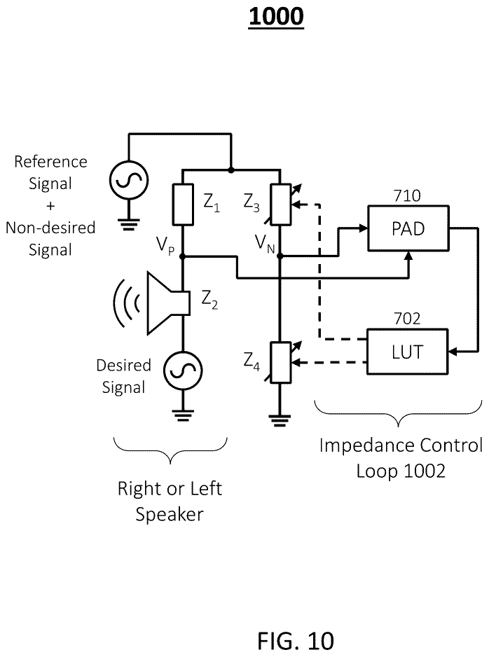

As previously noted, the control of the virtual branch impedances can be achieved by either a control loop, a LUT with PAD, or any other form of control, such as, an Artificial Intelligence (AI) algorithm. With reference to FIG. 10, there is depicted another embodiment of a PAD 710 and LUT 702 configuration 1000. It will be appreciated that the control loop 1002 of the configuration 1000 can be implemented in at least one of an analog domain and digital domain.

In configuration 1000, the phase and amplitude differences between the Vₚ and Vₙ signals are first determined by the PAD 710, which forwards the determined amplitude and phase differences to the LUT 702. The LUT 702 then provides the appropriate impedance control values corresponding to the determined amplitude and phase differences. The LUT 702 impedance control values are then supplied to the variable Z₃ and Z₄ impedances of the virtual branch to match the impedance of Z₁ and Z₂ of the real branch so as to enable the Vₚ−Vₙ signal to cancel the undesired stereo audio signal and isolate the desired stereo audio signal.

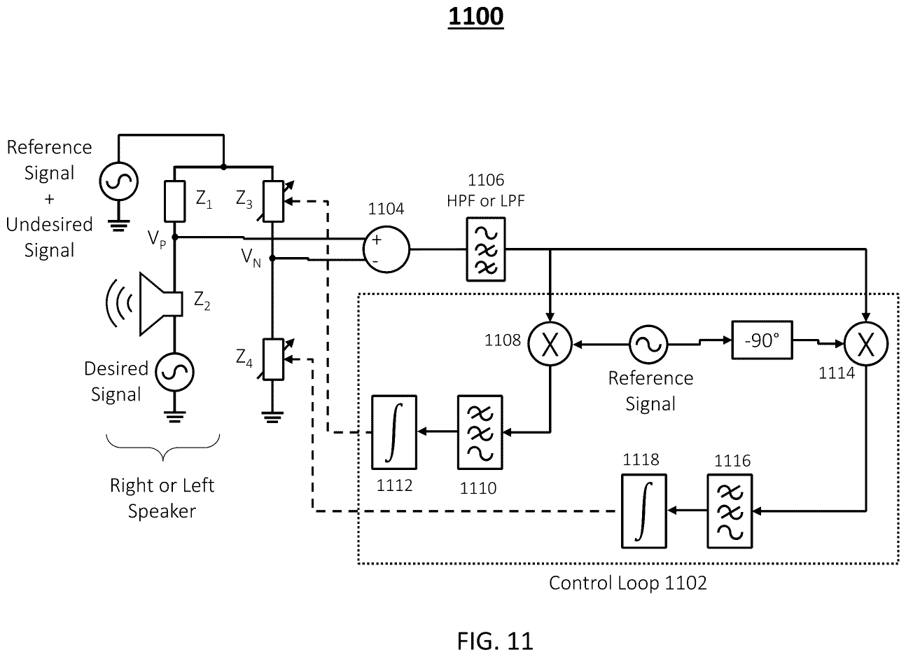

FIG. 11 depicts a further control loop 1102 for the isolation of the desired stereo audio signal in the presence of undesired stereo audio signals. As shown, the adjustable Z₃ and Z₄ impedances of the virtual branch are tuned to match the impedance levels Z₁, Z₂ of the real branch of the modified Maxwell-Wien Bridge arrangement 30B (which includes the speaker) to ensure that the Vₙ signal is substantially equal to Vₚ signal in order to cancel the undesired stereo audio signals.

In particular, the Vₙ signal will generally manifest a different amplitude and phase from the Vₚ signal. The control loop 1102 operates to determine the amplitude and phase difference between the Vₚ and Vₙ signals. As shown, the subtractor element 1104 generates the difference Vₚ−Vₙ signal with is then filtered by filter 1106. The filtered Vₚ−Vₙ signal forwarded to multiplier 1108 to multiply the signal with a reference signal. The reference signal is then filtered by filter 1110 and integrated 1112. The integrated signal is supplied to the real branch to adjust the variable impedance Z₃ to match the amplitude of the V_{undesired} signal.

Commensurately, the filtered Vₚ−Vₙ signal is also forward to mixer 1114 that mixes the signal with the reference signal shifted by 90°. The resultant mixed signal is then filtered 1116 and integrated 1118. The integrated signal is supplied to the virtual branch to adjust the variable impedance Z₄ to match the phase of the V_{undesired} signal.

Upon determining the amplitude and phase differences, the impedances of Z₃ and Z₄ are dynamically adjusted such that the amplitude and phase of the Vₙ signal becomes substantially the same as the Vₚ signal. In this manner, the Vp−Vn operation results in the cancellation of the undesired signals and isolates the desired signal for further processing.

### Digital and Full-Band AC Bridges

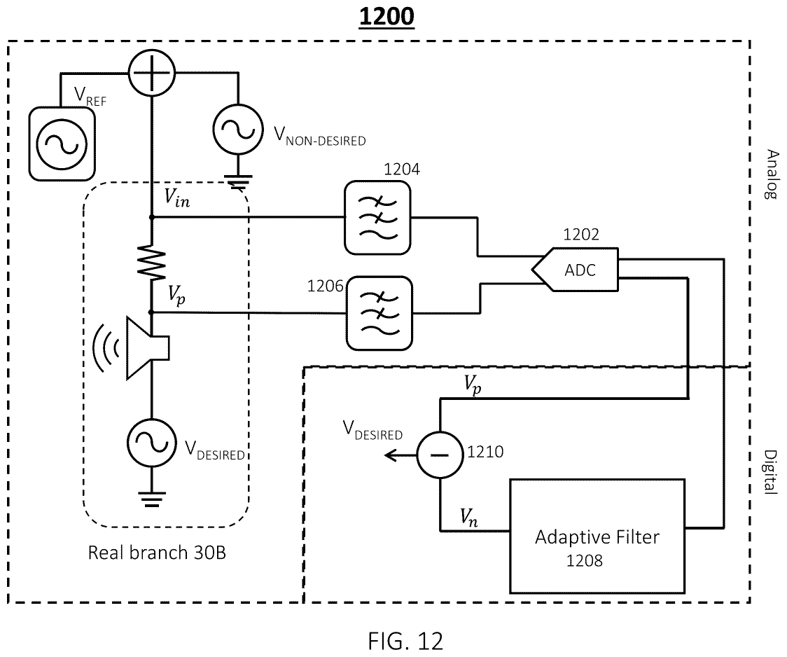

In the configuration 1200 of FIG. 12, developers have provided an additional approach to model the virtual speaker of the modified Maxwell-Wien Bridge arrangement 30B in the digital domain, in accordance with at least some embodiments of the present technology. For the sake of clarity, we rely on the previous descriptions of similar elements and features and only certain elements that are relevant to the understanding of this concept will be described.

In configuration 1200, an ADC 1202 with anti-aliasing filters 1204, 1206 is used to capture the signal before the bridge arrangement (Vin). It can also be said that the ADC 1202 with anti-aliasing filters 1204, 1206 is used to capture the signal directly from the real branch speaker (Vp). Both signals are passed through a digital adaptive filter 1208, as shown in FIG. 12, in which the digital adaptive filter 1208 is modeled after the impedance levels of the virtual branch. That is, the coefficients of the digital adaptive filter 1208 represent the virtual branch of the modified Maxwell-Wien Bridge arrangement 30B.

As shown, Vᵢₙ signal containing the V_{ref} and V_{undesired} signal components and the and Vₚ signal are forwarded to filters 1204, 1206 (either low pass or high pass filters depending on the frequency band of interest as prescribed by the V_{REF} signal). The filtered Vᵢₙ and Vₚ signals are supplied to a high-resolution ADC 1202 for converting the Vᵢₙ and Vₚ signals into digital values. The digital Vᵢₙ values are then supplied to the digital adaptive filter 1208 configured to generate a Vₙ signal value that matches the Vₚ signal. The FIG. 12 configuration then performs the Vₚ−Vₙ signal value subtraction to cancel the V_{undesired} signal and isolate the V_{desired} signal for further processing.

In some embodiments, the adaptive filter 1208 can run continuously with a reference signal, and/or it can be used inside a “calibration” phase where the calibrated coefficients are stored to be used without the reference signal.

It is also contemplated that the calibrated coefficients from the adaptive filter 1208 can be used to implement a digital version of the virtual branch that is identical to the real branch, thus allowing for the cancellation of the undesired audio signal in the digital domain.

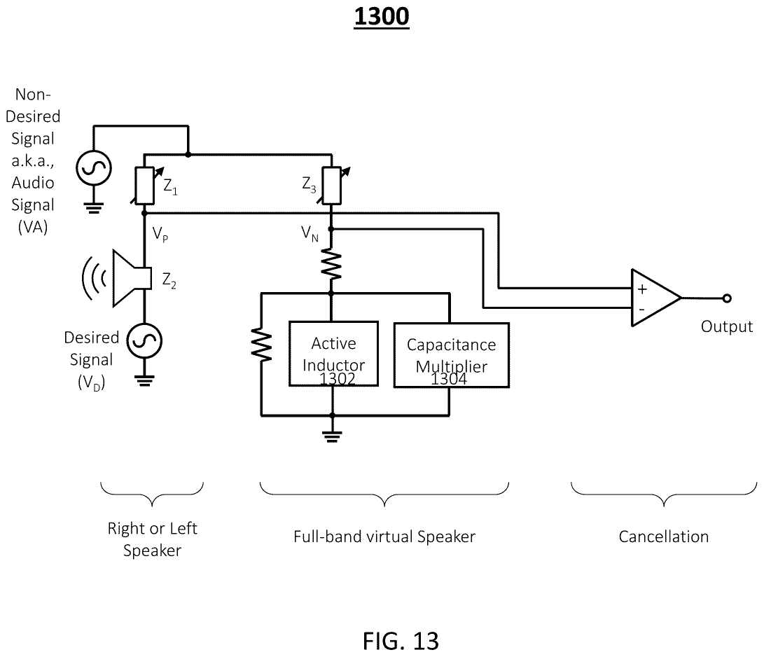

In FIG. 13, developers have provided a Full-Band AC Bridge configuration 1300. By using active components, resistors, and capacitors, it is possible to create a full-band circuit that is equivalent to the electrical model of a speaker. This approach can be used to replace sometimes “unpractical” values of inductors and capacitors needed to match the speaker electrical model, which would otherwise be too bulky for at least some applications contemplated within the context of the present technology.

As an example, active inductor circuits 1302 can produce inductive behaviour without the use of any inductor. Likewise, large capacitances can be produced using active capacitance multiplier 1304. These circuit blocks can be implemented in different ways in the context of the present technology. The developers of the present technology have devised methods, circuits, and systems that implement these circuit blocks to generate a full-band AC bridge (e.g., virtual speaker) to cancel the undesired audio signals to isolate the desired signal from the speakers.

### Concepts

Without wishing to be bound to any specific theory, developers have realized that a final output signal can be computed using the principal of superposition, by separately calculating its contribution from the audio perspective (V_{A}), and from the desired signal perspective (V_{D}).

For example, V_{P} and V_{Nn} signals in FIG. 8 can be computed from the perspective of the audio by taking the voltage divider from V_{A} with V_{D} grounded, as follows:

$${V}_{P} ( f ) = \frac{{Z}_{2}}{{Z}_{1} + {Z}_{2}} {V}_{A} ( f )$$

$${V}_{N 1} ( f ) = \frac{{Z}_{4}}{{Z}_{3} + {Z}_{4}} {V}_{A} ( f ) {\vert}_{f < {f}_{1}}$$

$${V}_{N 2} ( f ) = \frac{{Z}_{6}}{{Z}_{5} + {Z}_{6}} {V}_{A} ( f ) {\vert}_{f < {f}_{1} < {f}_{2}}$$

$${V}_{Nn} ( f ) = \frac{{Z}_{n}}{{Z}_{n - 1} + {Z}_{n}} {V}_{A} ( f ) {\vert}_{{f}_{n - 1} < f < {f}_{n}}$$

wherein Z is the impedances used in the circuit, Z₁ represents the resistor that is used to detect the desired signal, Z₂ is the electrical representation of the speaker, Z₃ and Z₄ are controlled in order to make V_{N1} equal to Vₚ at a given frequency. Broadly, Zₙ₋₁ and Zₙ (n>=4), are the impedances to be controlled.

At the output of the instrumentation amplifier, the difference between V_{P} and any given V_{Nn} is:

$${V}_{P} ( f ) - {V}_{Nn} ( f ) = ( \frac{{Z}_{2}}{{Z}_{1} + {Z}_{2}} - \frac{{Z}_{n}}{{Z}_{n - 1} + {Z}_{n}} {\vert}_{{f}_{n - 1} < f < {f}_{n}} ) {V}_{A} ( f )$$

This means that when the two ratios of the subtraction are equals given a certain bandwidth (fₙ₋₁<f<fₙ), the signal V_{A} (fₙ₋₁<f<fₙ) will be reduced, or completely cancelled.

This process can be performed for different bands, then selective filters can be used to select the respective band before they can all be summed up, as shown in the equation below:

$${V}_{out ( {V}_{A} )} = [ {V}_{P} ( f ) - {V}_{N 1} ( f < {f}_{1} ) ] {\vert}_{LPF @ f 1} + [ {V}_{P} ( f ) - {V}_{N 2} ( {f}_{1} < f < {f}_{2} ) ] {\vert}_{BPF @ f 1 , f 2} + ⋯ + [ {V}_{P} ( f ) - {V}_{Nn} ( {f}_{n - 1} < f < {f}_{n} ) ] {\vert}_{BPF @ fn - 1 , fn}$$

In FIG. 8 V_{P}, and V_{Nn} can be computed from the perspective of the desired signal by taking the voltage divider from V_{D} with V_{A} grounded, as the follows:

$${V}_{P} ( f ) = \frac{{Z}_{1}}{{Z}_{1} + {Z}_{2}} {V}_{D} ( f )$$

$${V}_{Nn} ( f ) = \frac{{Z}_{3}}{{Z}_{3} + {Z}_{4}} \times 0 = 0$$

Since there is no signal coming from any V_{Nn} branch, the difference at the output of the instrumentation amplifier is defined as:

$${V}_{P} ( f ) - {V}_{Nn} ( f ) = \frac{{Z}_{1}}{{Z}_{1} + {Z}_{2}} {V}_{D} ( f ) - 0 , or {V}_{P} ( f ) = \frac{{Z}_{1}}{{Z}_{1} + {Z}_{2}} {V}_{D} ( f )$$

This can be performed for different bands, then selective filters can be used to select the respective band before they can all be summed up, as shown in the equation below:

$${V}_{out ( {V}_{D} )} = {V}_{P} ( f < {f}_{1} ) {\vert}_{LPF @ f 1} + {V}_{P} ( {f}_{1} < f < {f}_{2} ) {\vert}_{BPF @ f 1 , f 2} + ⋯ + {V}_{P} ( {f}_{n - 1} < f < {f}_{n} ) {\vert}_{BPF @ fn - 1. fn}$$

Therefore, the final output signal is simply the addition of both contributions (audio and desired signals), as follows:

$${V}_{out} = {V}_{out ( {V}_{A} )} + {V}_{out ( {V}_{D} )}$$

Since V_{out(V}_{_{A}}₎ will tend to zero for each selective band, we can simplify the output signal as:

$${V}_{out} = {V}_{out ( {V}_{D} )} = {V}_{P} ( f < {f}_{1} ) {\vert}_{LPF @ f 1} + {V}_{P} ( {f}_{1} < f < {f}_{2} ) {\vert}_{BPF @ f 1 , f 2} + ⋯ + {V}_{P} ( {f}_{n - 1} < f < {f}_{n} ) {\vert}_{BPF @ fn - 1. fn}$$

### Systems

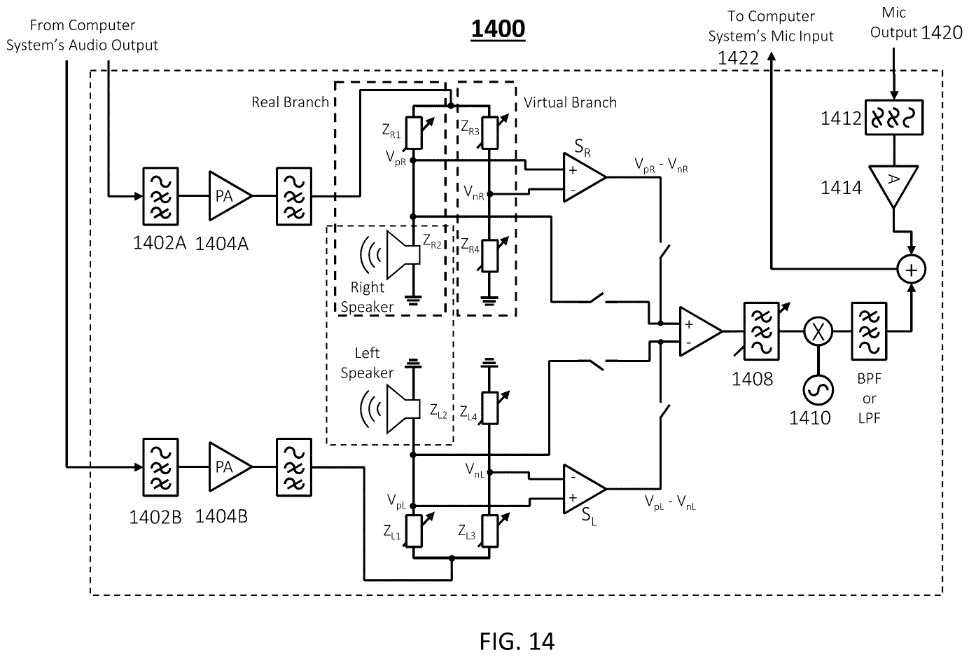

FIG. 14 depicts a system 1400 for performing stereo audio cancellation for isolation/extraction of headphone signals, in accordance with the embodiments of present disclosure.

Specifically, FIG. 14 shows a system 1400 for a real-life implementation that captures signals generated by the speakers' headphones while stereo music is being played to the user, as supplied by a computer system audio output. In this implementation, the music signal is the undesired signal, and the signals coming from the speakers are the desired signals. The music signal can be delivered to the left and right speakers in different ways. For example, a wide variety of wireless protocols, such as classical or low-energy Bluetooth, Wi-Fi, or any other proprietary protocol, can be used to deliver music signal to left and right speakers.

In FIG. 14, a multi-band AC bridge may be implemented as described above. However, for the sake of clarity and tractability, only one virtual speaker branch tuned to only one band is shown and previously described elements and features will not be described. Additionally, or alternatively, the system 1400 of FIG. 14 may be implemented for processing multiple bands.

As shown, for both the right and left channels, the stereo audio signals outputted by the computer system convey the undesired signal. The undesired signal for both the right and left channels is respectively filtered 1402A, 1402B and buffered (e.g., power amplifier 1404A, 1404B) and subsequently supplied to both the right and left speakers.

As further shown, for the right speaker channel, the real branch of the multi-band AC bridge contains the V_{pR} signal along with impedances Z_{R1} and Z_{R2} (shown as the right speaker) while the virtual branch contains the V_{nR} signal along with adjustable impedances Z_{R3} and Z_{R4}. Commensurately, for the left speaker channel, the real branch multi-band AC bridge contains the V_{pL} signal along with impedances Z_{L1} and Z_{L2} (shown as the left speaker) while the virtual branch contains the V_{nL} signal along with adjustable impedances Z_{L3} and Z_{L4}.

As discussed above, the impedances of the virtual branches for the right and left speakers, namely, Z_{R3}, Z_{R4} and Z_{L3}, Z_{L4}, respectively, are dynamically adjusted to match the corresponding impedances of the real branches, namely, Z_{R1}, Z_{R2} and Z_{L1}, Z_{L2}, respectively. In this manner, for the right speaker channel, the corresponding subtractor device S_{R} is configured to perform the V_{pR} signal−V_{nR} signal operation to cancel the right channel undesired signals and isolate the right channel desired signals for further processing.

Similarly, for the left speaker channel, the corresponding subtractor device S_{L} is configured to perform the V_{pL} signal−V_{nL} signal operation to cancel the left channel undesired signals and isolate the left channel desired signals for further processing.

As illustrated, the resultant outputs of the S_{R} and S_{L} subtractors may be switched to select to at least one of (i) to cancel the undesired signal and maintain the desired one, and (ii) to directly capture the desired one with or without the undesired signal.

The selected outputs of the S_{R} and S_{L} subtractors rendering the desired right and left channel signals may then be filtered 1408 for conditioning and supplied to a mixer 1410 for frequency translation. This essentially functions as a continuous calibration control loop for adjusting the output. In other implementations, a one-time calibration may be performed by acquiring the phase and amplitude difference and adjusting the impedances only once (without the continuous calibration control loop).

Such calibration may be useful in a case where the output of the system is being sent through a band-limited wireless system, like a Bluetooth system, for example. In this case, the system may be configured to choose where to position the output signal inside the already limited band of the Bluetooth system.

Additionally, the configuration 1400 of FIG. 14 incorporates a microphone signal 1420 that is outputted by a commercial microphone, in which the outputted microphone signal 1420 is conditioned (i.e., filtered and amplified) and subsequently added to the selected, frequency-translated desired signal output.

Moreover, it will be appreciated that Bluetooth headphones send microphone information using a limited band, for example 8 kHz band. If the system wants to output a signal outside that band, it can use the mixer stage to reposition the desired signal into the limited band of the external system. Developers of the present technology have realized that, by using time division multiplexing, the desired signal may have its wideband information, for example 24 kHz, split into smaller bands of 8 kHz each, filtered by a bandpass or low pass filter and have them sent over different moments in time (e.g., consecutively). The output of the system adds the conditioned microphone signal (if available) to the output of the mixer stage, which may also be bypassed if not required, either by a switch (not shown), or other method.

It should be understood that the system 1400 illustrated by FIG. 14 is but one example of systems contemplated within the context of the present technology. Systems in the context of the present technology can be embodied in different ways, such as having multiple branches of the multi-band AC bridge, and/or with left and right independent outputs with their own mixing stages, for example.

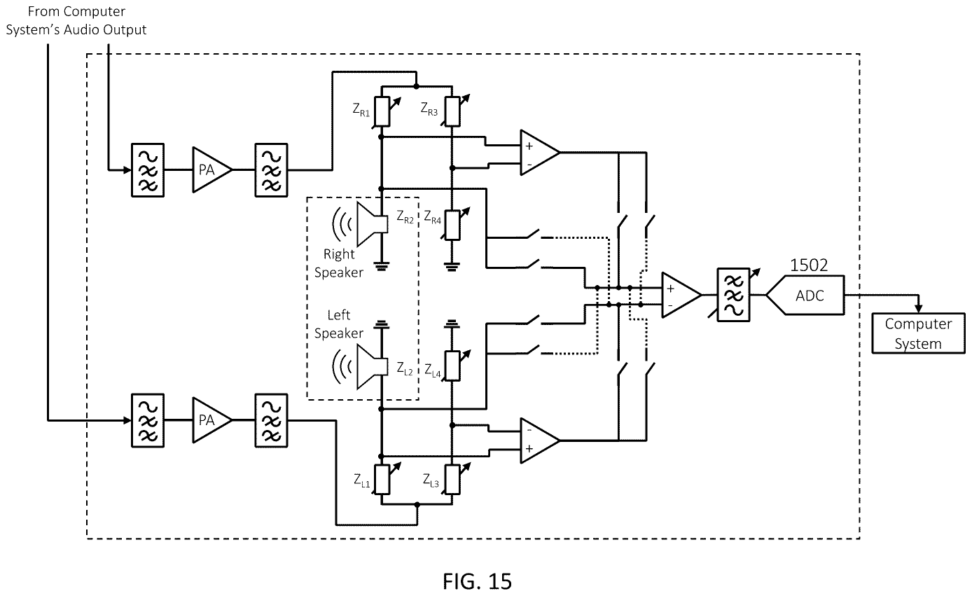

FIGS. 15-18 depict various alternative configurations to the real-life implementation 1400 of FIG. 14 relative to how the selected outputs of the S_{R} and S_{L} subtractors rendering the right and left channel desired signals may be supplied to the computer system for further processing. For the sake of clarity and tractability, we rely on the previous detailed descriptions of like elements and features such that only certain elements that are relevant to the understanding of intended concepts will be described.

With this said, FIG. 15 depicts an alternative implementation 1500 incorporating only one high-resolution ADC and for which the right and left channel desired signals are provided to the computer system for further processing. As shown, the right and left channel desired signals are filtered and subsequently provided to an ADC 1502. The ADC 1502 can receive either both channels separately or their differences. The output of the ADC 1502 can then be sent to a host device through either I2C, SPI, BLE, Bluetooth, or any other type of data transmission protocol. Additionally, the two analog signals can be converted into digital signals in an interleaved way. The control of impedances and other parameters of the system, like gain or sampling frequency, can be sent using the protocols already non-exhaustively listed above for the data transmission purposes, e.g., I2C, SPI, BLE, etc.

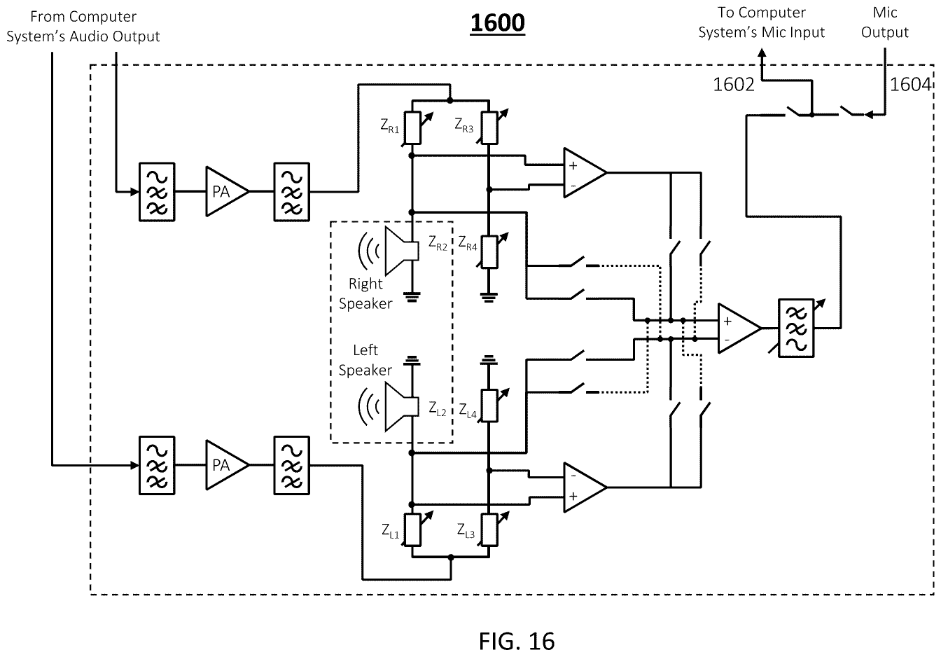

FIG. 16 depicts an alternative implementation 1600 in which the right and left channel desired signals are provided to the computer system for further processing. In the depicted configuration 1600, the existing microphone's input 1602 is used to send the desired signal by switching between the microphone's input 1602 and output 1604.

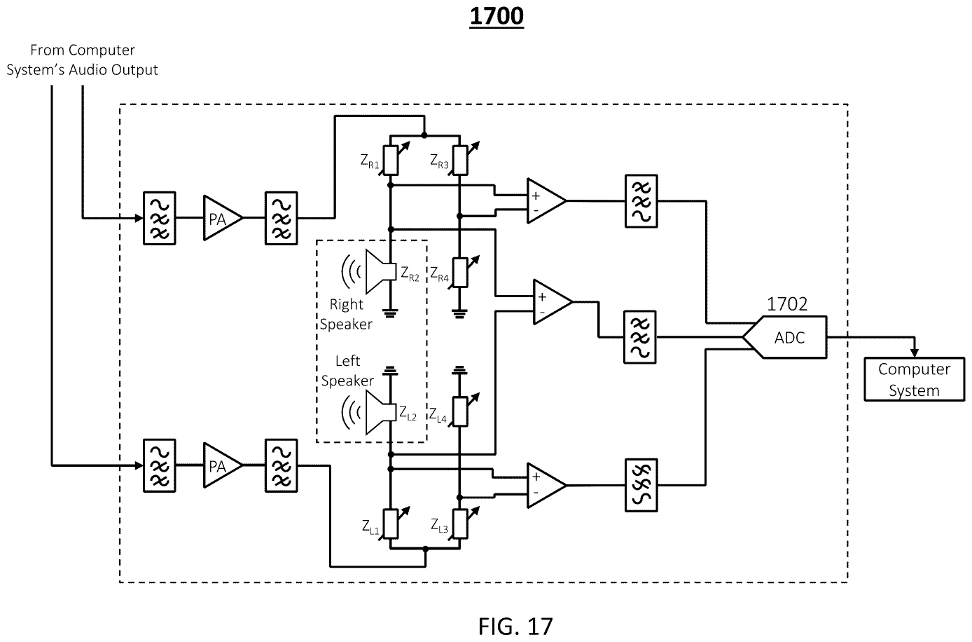

FIG. 17 depicts an additional alternative implementation 1700 in which the right and left channel desired signals are provided to the computer system for further processing. In the depicted configuration 1700, all of the outputs are directed to an onboard ADC 1702 before forwarding the digitized information to the computer system.

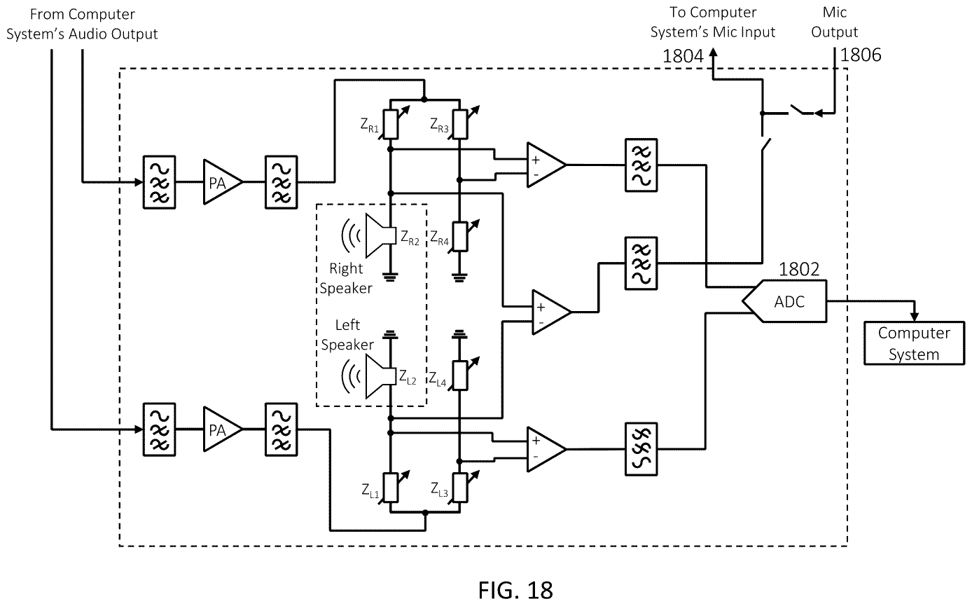

FIG. 18 depicts an additional alternative implementation 1800 in which the right and left channel desired signals are provided to the computer system for further processing. In essence, the depicted configuration 1800 employs the single high-resolution ADC 1802 (as discussed relative to FIG. 17) and the reuse of the microphone's input 1804 to send the desired signal by switching between the microphone's input 1804 and output 1806.

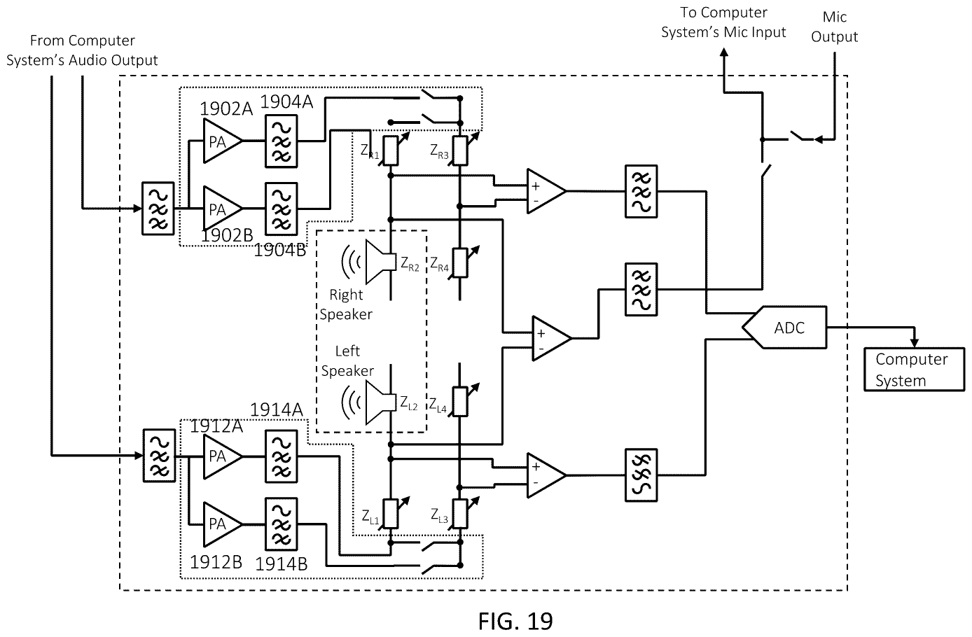

FIG. 19 depicts a further implementation 1900 in which the right and left channel desired signals are provided to the computer system for further processing. In the depicted configuration 1900 dual power amplifier buffers 1902A, 1902B, 1912A, 1912B and corresponding filters 1904A, 1904B, 1914A, 1914B are incorporated to the configuration 1800 of FIG. 18. In particular, for each of the right and left speakers, a power amplifier buffer 1902A, 1902B, 1912A, 1912B and filter 1904A, 1904B, 1914A, 1914B is applied to each of the real and virtual branches.

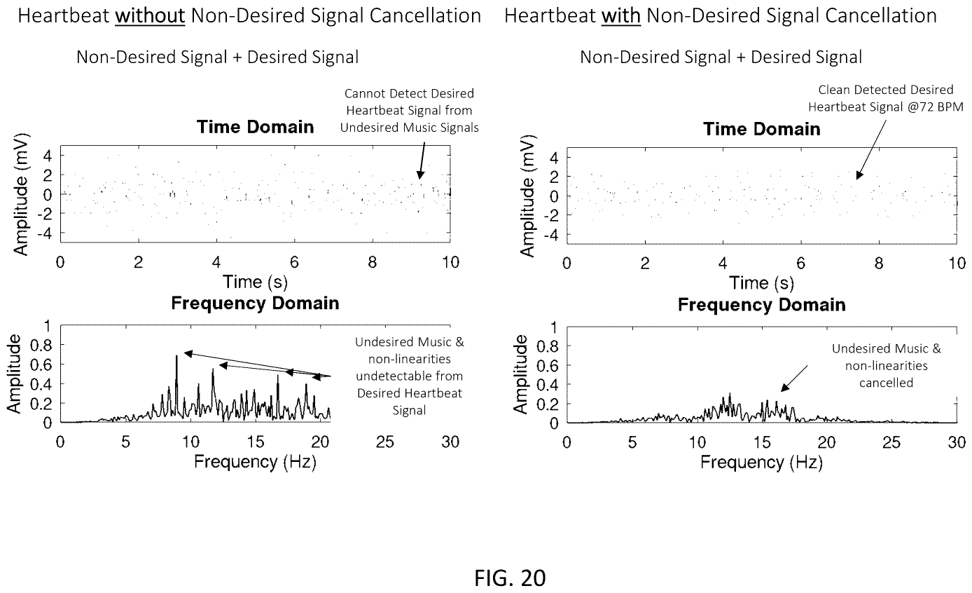

FIG. 20 depicts graphical empirical time and frequency responses that compare desired signals (e.g., desired heartbeat signal) in the presence of the undesired stereo audio signals without undesired signal cancellations (see, left side of FIG. 20) to the undesired signal cancellations isolation of the desired signals (e.g., desired heartbeat signal) as provided by the various embodiments of the present disclosure (see, right side of FIG. 20). As clearly shown by the graphical empirical responses, without the undesired signal cancellation provided by the various embodiments of the present disclosure, the isolation and extraction of the desired signal for further processing would not be feasible.

It will be appreciated that, while the disclosed embodiments have been described in terms of system configurations/components for clarity and tractability, the related methods and processes regarding the execution of the operations of the disclosed configurations/components should be clearly understood by artisans of ordinary skill in the art.

With this said, modifications and improvements to the above-described implementations of the present technology may become apparent to those skilled in the art. The foregoing description is intended to be exemplary rather than limiting. The scope of the present technology is therefore intended to be limited solely by the scope of the appended claims.

What is claimed is:

1. A system for isolating a desired signal for analysis within the presence of an undesired audio signal, comprising:
a receiver configured to receive and forward the desired signal and the undesired audio signals; and
a bridge arrangement communicatively-coupled to the receiver and configured to receive and process the desired signal and the undesired audio signal, the bridge arrangement comprising a first branch containing a resistor-inductor segment having a first impedance level and a second branch containing an adjustable resistor-capacitor segment having an adjustable second impedance level;
wherein, the desired and undesired signals are routed to the first branch to comprise a Vₚ voltage signal and the undesired stereo signals are routed to the second branch to comprise a Vₙ voltage signal; and
wherein, the second impedance level of the second branch is dynamically adjusted to match the first impedance level of the first branch, such that a difference between the voltage signals Vp−Vn results in the cancellation of the undesired stereo audio signals such that the desired signal remains isolated for further processing.

2. The system of claim 1, wherein the resistor-inductor and the variable resistor-capacitor segments include an input one-way buffer to prevent reduction of the desired signal.

3. The system of claim 2, wherein the input one-way buffer comprises an amplifier.

4. The system of claim 1, wherein the dynamic adjustment of the variable resistor-capacitor segment is performed by a control loop comprising:
a first voltage reference tone V_{REF} and a second voltage reference tone V_{REF-90} orthogonal to the first reference tone, the first and second voltage reference tones V_{REF}, V_{REF-90} corresponding to the Vp and Vn signal voltages;
a subtractor element configured to determine the voltage difference Vp−Vn, amplify and forward the result of the amplified voltage difference signal;
a first filter configured to isolate the amplified voltage difference Vp−Vn signal;
a mixer arrangement configured to mix the isolated amplified voltage difference Vp−Vn signal with the first voltage reference tone V_{REF} and a second voltage reference tone V_{REF-90} to determine in-phase and out-of-phase voltage signals;
an in-phase feedback controller configured to receive the in-phase voltage signal and generate a feedback voltage signal Vr; and
an out-of-phase feedback controller configured to receive the out-of-phase voltage signal and generate a feedback voltage signal Vi;
wherein the feedback voltages signals Vr and Vi are forwarded to the variable resistor-capacitor segment to adjust the variable resistance values and match the first impedance level of the resistor-inductor segment to nullify the undesired audio signal and isolate the desired signal V_{desired}.

5. The system of claim 4, further comprising an analog-to-digital converter (ADC) configured to digitize the desired signal V_{desired} and forward the digital V_{desired} values for further processing.

6. The system of claim 1, wherein the dynamic adjustment of the variable resistor-capacitor segment is performed by a control structure comprising:
a first voltage reference tone V_{REF} corresponding to the Vₚ and Vₙ signal voltages;
a subtractor element configured to determine the voltage difference Vₚ−Vₙ, and forward the result of the voltage difference signal;
a first filter configured to isolate the voltage difference Vₚ−Vₙ signal;
a phase and amplitude detector (PAD) configured to output a signal indicative of the phase and amplitude differences between the Vₚ and Vₙ signal voltages; and
a look-up table configured to store the outputted phase and amplitude differences and output feedback voltages signals Vr and Vi;
wherein the feedback voltages signals Vr and Vi are forwarded to the variable resistor-capacitor segment to adjust the variable resistance values and match the first impedance level of the resistor-inductor segment to nullify the undesired audio signal and isolate the desired signal V_{desired}.

7. The system of claim 6, further comprising an analog-to-digital converter (ADC) configured to digitize the V_{desired} signal and forward the digital V_{desired} values for further processing.

8. The system of claim 1, wherein the configuration is implemented to operate as multi-band AC bridge (MBACB) for isolating the desired signal within a single frequency band-of-interest or across multiple frequency bands-of-interest.

9. The system of claim 1, wherein the dynamic adjustment of the variable resistor-capacitor segment is performed by a digital control structure comprising:
a first voltage reference tone V_{REF} corresponding to the Vₚ and Vₙ signal voltages;
a second voltage signal Vᵢₙ containing the V_{REF} and the undesired signal;
a first filter configured to filter the Vᵢₙ voltage signal;
a second filter configured to filter the Vₚ voltage signal;
an analog-to-digital converter (ADC) configured to digitize the Vᵢₙ and Vₚ signals into Vᵢₙ and Vₚ values, respectively;
a digital adaptive filter comprising operating digital coefficients representative of impedance levels for the second branch, the digital adaptive filter configured to receive the Vᵢₙ and Vₚ values to generate a Vₙ value that matches the Vₚ value; and
a subtractor element configured to calculate the difference between the Vₚ and Vₙ values to cancel the undesired signal V_{undesired} and isolate the desired signal V_{desired}.

10. The system of claim 8, wherein the MBACB comprises:
a right speaker channel containing:
a right first branch voltage signal V_{pR} representing the Vₚ voltage signal for the right speaker channel;
a right first branch fixed impedance level;
a right second branch voltage signal V_{nR} representing the Vₙ voltage signal for the right speaker channel; and
a right second branch adjustable impedance level; and
a left speaker channel containing:
a left first branch voltage signal V_{pL} representing the Vₚ voltage signal for the left speaker channel;
a left first branch fixed impedance level;
a left second branch voltage signal V_{nL} representing the Vₙ voltage signal for the left speaker channel; and
a left second branch adjustable impedance level;
wherein, the second branch impedance levels of the right and left speaker channels are dynamically adjusted to match the corresponding first branch impedance levels of the right and left speaker channels, and
wherein, the V_{nR} signal is subtracted from the V_{pR} signal operation to cancel the right channel undesired signals and isolate the right channel desired signals and the V_{nL} signal is subtracted from the V_{pL} signal to cancel the left channel undesired signals and isolate the left channel desired signals.

11. A method for isolating a desired signal for analysis within the presence of an undesired audio signal, comprising:
receiving, by a receiver, the desired signal and the undesired audio signals;
receiving, by a bridge arrangement that is communicatively-coupled to the receiver, the desired signal and the undesired audio signals, the modified Maxwell-Wien Bridge arrangement comprising a first branch containing a resistor-inductor segment having a first impedance level and a second branch containing an adjustable resistor-capacitor segment having an adjustable second impedance level;
routing the desired and undesired stereo signals to the first branch to comprise a Vₚ voltage signal and routing the undesired stereo signal to the second branch to comprise a Vₙ voltage signal; and
dynamically adjusting, the second impedance level of the second branch to match the first impedance level of the first branch, such that a difference between the voltage signals Vₚ−Vₙ results in the cancellation of the undesired audio signal such that the desired signal remains isolated for further processing.

12. The method of claim 11, further comprising incorporating an input one-way buffer to the resistor-inductor and the variable resistor-capacitor segments to prevent reduction of the desired signal.

13. The method of claim 11, further comprising digitizing, by an analog-to-digital converter (ADC), the V_{desired} signal and forward the digital V_{desired} values for further processing.

14. The method of claim 11, wherein the dynamic adjustment of the variable resistor-capacitor segment comprises:
applying a first voltage reference tone V_{REF} and a second voltage reference tone V_{REF-90} orthogonal to the first reference tone, the first and second voltage reference tones V_{REF}, V_{REF-90} corresponding to the Vp and Vn signal voltages;
determining a voltage difference Vp−Vn and amplifying the voltage difference result;
isolating, by a first filter, the amplified voltage difference Vp−Vn signal;
mixing the isolated amplified voltage difference Vp−Vn signal with the first voltage reference tone V_{REF} and a second voltage reference tone V_{REF-90} to determine in-phase and out-of-phase voltage signals;
receiving the in-phase voltage signal and generating a feedback voltage signal Vr;
receive the out-of-phase voltage signal and generating a feedback voltage signal Vi; and
forwarding the feedback voltages signals Vr and Vi to the variable resistor-capacitor segment and adjusting the variable resistance values to match the first impedance level of the resistor-inductor segment to nullify the undesired audio signal and isolate the desired signal.

15. The method of claim 14, further comprising digitizing the desired signal V_{desired} and forwarding the digital V_{desired} values for further processing.

16. The method of claim 11, wherein the dynamic adjustment of the variable resistor-capacitor segment comprises:
applying a first voltage reference tone V_{REF} corresponding to the Vₚ and Vₙ signal voltages;
determining a voltage difference Vₚ−Vₙ;
isolating, by a first filter, the voltage difference Vₚ−Vₙ signal;
outputting, by a phase and amplitude detector (PAD), a signal indicative of the phase and amplitude differences between the Vₚ and Vₙ signal voltages;
storing, by a look-up table, the outputted phase and amplitude differences and outputting feedback voltages signals Vr and Vi; and
forwarding, the feedback voltages signals Vr and Vi to the variable resistor-capacitor segment to adjust the variable resistance values and match the first impedance level of the resistor-inductor segment to nullify the undesired audio signal and isolate the desired signal V_{desired}.

17. The method of claim 16, further comprising digitizing the desired signal V_{desired} and forwarding the digital V_{desired} values for further processing.

18. The method of claim 11, further comprising implementing a multi-band AC bridge (MBACB) for isolating the desired signal within a single frequency band-of-interest or across multiple frequency bands-of-interest.

19. The method of claim 11, wherein the dynamic adjustment of the variable resistor-capacitor segment comprises:
applying a first voltage reference tone V_{REF} corresponding to the Vₚ and Vₙ signal voltages;
applying a second voltage signal Vᵢₙ containing the V_{REF} and the undesired signal;
filtering, by a first filter, the Vᵢₙ voltage signal;
filtering, by a second filter, the Vₚ voltage signal;
digitizing, by an analog-to-digital converter (ADC), the Vᵢₙ and Vₚ signals into Vᵢₙ and Vₚ digital values, respectively;
receiving, by a digital adaptive filter, the Vᵢₙ and Vₚ digital values to generate a Vₙ value that matches the Vₚ value; and
calculating a difference between the Vₚ and Vₙ values to cancel the undesired signal V_{undesired} and isolate the desired signal V_{desired}.

20. The method of claim 18, wherein the implementation of the multi-band AC bridge (MBACB) comprises:
implementing a right speaker channel comprising:
providing a right first branch voltage signal V_{pR} representing the Vₚ voltage signal for the right speaker channel;
providing a right first branch fixed impedance level;
providing a right second branch voltage signal V_{nR} representing the Vₙ voltage signal for the right speaker channel; and
providing a right second branch adjustable impedance level;
implementing a left speaker channel comprising:
providing a left first branch voltage signal V_{pL} representing the Vₚ voltage signal for the left speaker channel;
providing a left first branch fixed impedance level;
providing a left second branch voltage signal V_{nL} representing the Vₙ voltage signal for the left speaker channel; and
providing a left second branch adjustable impedance level;
dynamically adjusting the second branch impedance levels of the right and left speaker channels to match the corresponding first branch impedance levels of the right and left speaker channels, and
subtracting the V_{nR} signal from the V_{pR} signal to cancel the right channel undesired signals and isolate the right channel desired signals and subtracting the V_{nL} signal from the V_{pL} signal to cancel the left channel undesired signals and isolate the left channel desired signals.
